(19) United States
(12) Patent Application Publication
(10) Pub. No.: US 2005/0235520 A1
(43) Pub. Date: Oct. 27, 2005

(54) Apparatus for drying a vehicle

(76) Inventors: Kenneth J. Dollhopf, Green Bay, WI (US); Mark N. Showers, Menasha, WI (US); Rodney J. Peer, Green Bay, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/113,548

(22) Filed: Apr. 25, 2005

Related U.S. Application Data
(60) Provisional application No. 60/565,414, filed on Apr. 26, 2004.

(51) Int. Cl. F26B 19/00; F26B 13/10

(52) U.S. Cl. 34/666; 34/524

(57) ABSTRACT

A dryer assembly for use with a vehicle washing system that includes a plurality of individual blower assemblies in a generally inline configuration. As a vehicle passes beneath dryer assembly, the plurality of blower assemblies create an enhanced air flow across the priority areas of the vehicle. As the vehicle moves further relative to the dryer assembly, first and second movable blower assemblies move away from the center axis of the vehicle and into alignment with the first and second side of the vehicle to direct water off of the vehicle. Upon detection of a second priority area, the first and second movable blower assemblies move back into a center position to direct a maximum air flow onto the vehicle. The first and second movable blower assemblies each include sensors that allow the movable blower assemblies to locate the sides of the vehicle.

### CROSS-RELATED PATENT INFORMATION

The present invention is based on and claims priority to U.S. Provisional Patent Application Ser. No. 60/565,414, filed on Apr. 26, 2004.

### FIELD OF THE INVENTION

The present invention relates to a commercial system for drying vehicles, such as after the vehicle has been washed by an automatic in-bay or tunnel car wash. More specifically, the present invention relates to a vehicle dryer and method of operation that optimizes the drying process to provide enhanced vehicle drying over designated priority areas of the vehicle.

### BACKGROUND OF THE INVENTION

Numerous systems are currently known for the automatic washing and drying of a vehicle. In such prior art systems, the vehicle either remains stationary or is moved as the washing and drying operations are performed. In an in-bay wash system in which the vehicle remains stationary, a spray arch moves around the outer peripheral area of the vehicle and sprays water and chemical agents onto the vehicle to perform the wash process. In a tunnel system, the vehicle is moved through a series of individual wash stations that use either chemical agents or friction to remove dirt from the vehicle.

In both an in-bay and tunnel vehicle washing system, the vehicle passes beneath a vehicle dryer once the wash process is complete. Typically, the vehicle dryer assembly includes a plurality of blower nozzles that are spaced across the width of the vehicle. Each of these nozzles is positioned to direct a flow of air onto the vehicle to blow the water droplets from the vehicle surface to complete the drying process.

In one type of prior art drying system, a vehicle passes beneath a blower assembly that includes a series of blower nozzles positioned transverse to the direction of movement of the vehicle. The dryer assembly includes a detector that senses the top surface of the vehicle and maintains the blower nozzles a constant distance from the top surface of the vehicle. Such a system is shown in U.S. Pat. No. 6,519,872. In this type of dryer assembly, the outlet nozzles of the dryer are maintained a constant distance from the vehicle surface regardless of the area of the vehicle being dried.

In another type of prior art system, such as shown and described in U.S. Pat. No. 5,596,818, three individual nozzles are positioned across the width of the vehicle. Although the nozzles oscillate in a cross-vehicle direction as well as along the direction of travel of the vehicle, the fixed spacing of the individual nozzles across the width of the vehicle limits the amount of air flow present at the vehicle surface.

A disadvantage of the prior art systems that include a plurality of fixed nozzles spaced across the width of the vehicle is that each of the nozzles must create its own flow of air that travels from the nozzle toward the surface area of the vehicle to be dried. In these systems, the individual nozzles must create their own air flow and do not capitalize on the air flow created by any of the other nozzles.

In prior art systems, the laterally spaced dryer nozzles create the same pattern of air flow onto the vehicle no matter which portion or area of the vehicle is currently beneath the dryer assembly. Thus, the areas of the vehicle deemed most important by the customer, such as the front hood and front windshield, do not receive any additional treatment as compared to less important areas, such as the vehicle top and back bumper. Thus, the prior art vehicle dryer assemblies do not provide enhanced drying to the areas deemed most important to the consumer.

### SUMMARY OF THE INVENTION

The present invention is a dryer assembly for drying a vehicle. The dryer assembly includes overhead blower assemblies that each direct a flow of air onto the vehicle, where one or more of the individual blower assemblies are selectively positionable based upon the area of the vehicle being dried. Unlike prior art vehicle dryers, the dryer assembly of the present invention prioritizes areas of the vehicle for drying and positions the blower assemblies in specific locations based upon the area of the vehicle being dried.

The dryer assembly includes at least one stationary center blower assembly that is positioned above the vehicle and includes an air outlet that is generally aligned with a center axis of the dryer. The stationary center blower assembly directs a flow of air onto the vehicle generally along the center axis of the dryer assembly during the entire drying process.

The dryer assembly further includes a first movable blower assembly and a second movable blower assembly that are each mounted above the vehicle and direct a flow of air onto the vehicle. Both the first and second movable blower assemblies are movable in a direction generally transverse to the center axis of the vehicle as the vehicle is moving relative to the dryer assembly.

Both the first movable blower assembly and the second movable blower assembly are mounted to a movable trolley such that the first and second blower assemblies are movable along a support rail. Each of the trolleys that support the first and second movable blower assemblies includes a drive member that can be operated to move the respective blower assembly between a center position and an outer position. When both the first and second movable blower assemblies are in the center position, an outlet nozzle of each of the blower assemblies is positioned near the center axis of the dryer assembly.

The dryer assembly includes a center vehicle sensor that detects the presence of the vehicle beneath the dryer assembly. Upon detecting a priority area of the vehicle, such as the front windshield, the first and second movable blower assemblies are moved from their center positions toward their respective outer positions. As the first and second movable blower assemblies move from the center position to the outer position, a vehicle sensor mounted on each of the first and second movable blower assemblies operates to detect the first and second sides of the vehicle.

Once the vehicle sensor associated with each of the first and second movable blower assemblies detects the side of the vehicle, the movement of the respective blower assembly is terminated such that each blower assembly assumes its outer position. When the first movable blower assembly is in its outer position, the air outlet of the first movable blower assembly is generally aligned above the first side of the motor vehicle. Likewise, when the second movable blower assembly is in its outer position, the air outlet of the second movable blower assembly is generally aligned with the second side of the vehicle.

As the vehicle continues to pass beneath the dryer assembly, the center vehicle position sensor detects a second priority area of the vehicle, such as the back windshield. Upon detection of the second priority area, the first and second movable blower assemblies are moved from their respective outer positions toward the center position to enhance the drying of the rear of the vehicle. Thus, the vehicle dryer assembly moves the first and second movable blower assemblies relative to the vehicle based upon priority zones of the vehicle.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is a perspective view of an overhead vehicle dryer assembly of the present invention;

FIG. 2 is a front view of the overhead vehicle dryer assembly as viewed by a vehicle passing beneath the dryer assembly;

FIG. 3 is a top view of the dryer assembly;

FIG. 4 is a magnified top view of the first and second movable blower assemblies, each in the center position;

FIG. 5 is a front view of the first and second movable blower assemblies in the center position;

FIG. 6 is a top view similar to FIG. 3 with the first and second movable blower assemblies moved from the center position to their respective outer positions;

FIG. 7 is a front view of the dryer assembly with the first and second movable blower assemblies in the position shown in FIG. 6;

FIG. 8 is a top view of the blower assemblies as a vehicle begins to pass beneath the dryer assembly;

FIG. 9 is a top view illustrating the detection of a first priority area of the vehicle as the vehicle moves further beneath the dryer assembly;

FIG. 10 is a top view illustrating the movement of the first and second movable blower assemblies to their respective outer positions generally aligned with the vehicle sides;

FIG. 11 is a front view of the vehicle positioned beneath the vehicle dryer assembly illustrating the alignment of the first and second movable blower assemblies with the first and second sides of the vehicle;

FIG. 12 is a top view illustrating the detection of a second priority area of the vehicle as the motor vehicle passes further beneath the dryer assembly;

FIG. 13 is a schematic illustration of the communication between the dryer control unit and the various operating components of the vehicle dryer assembly; and

FIG. 14 is a perspective view of an alternate, stationary embodiment of the vehicle dryer assembly of the present invention.

### DETAILED DESCRIPTION OF PREFERRED EMBODIMENTS

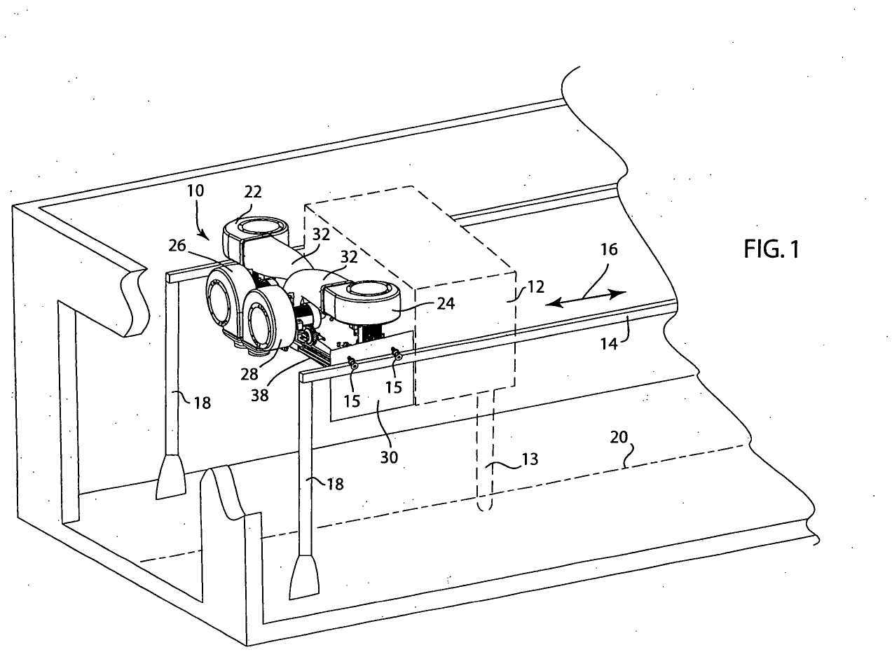

FIG. 1 illustrates the vehicle dryer assembly 10 of the present invention. As illustrated in FIG. 1, the dryer assembly 10 is a movable, self contained unit that is used along with an overhead gantry-type automated vehicle washing system 12 having a depending spray arch 13. An example of an overhead gantry-type automated vehicle washing system is the LaserWash® G5 motor vehicle washer available from PDQ Manufacturing, Inc. of Green Bay, Wis. The details of the overhead gantry washing system 12 are well known and the overhead gantry washing system 12 is only shown schematically throughout the figures. In general, the overhead gantry washing system 12 is mounted along a pair of spaced, overhead support rails 14 for movement in the direction shown by arrow 16. The overhead support rails 14 are preferably supported at each end by a pair of support legs 18. The overhead gantry wash system 12 includes an internal drive mechanism that moves the entire overhead gantry wash system 12 and attached dryer assembly 10 along the center axis 20. The center axis 20 is the center axis for both the motor vehicle dryer assembly 10 as well as the overhead gantry 12.

Although the dryer assembly 10 is shown and described as being a movable unit attached to or interated into the overhead gantry wash system 12, it should be understood that the dryer assembly 10 may be a stand-alone unit that is supported above the floor of the wash bay of an in-bay wash system, a gantry rollover wash system or at the end of a car wash tunnel. Throughout the following description, the vehicle will be described as moving relative to the dryer assembly 10. In the embodiment of the invention illustrated in FIG. 1, the wash assembly 12 and dryer assembly 10 are propelled relative to a stationary vehicle. However, it should be understood that the dryer assembly 10 could remain stationary and the vehicle moved relative to the dryer assembly.

Referring back to FIG. 1, the dryer assembly 10 defines an overhead gantry supported along the support rails 14 by a series of support rollers 15. The overhead gantry supports a first center blower assembly 22, a second center blower assembly 24, a first movable blower assembly 26 and a second movable blower assembly 28. The first and second center blower assemblies 22,24 are stationary relative to the overhead gantry of the dryer assembly 10 and are supported by a pair of side plates 30. The side plates 30 are positioned on opposite, lateral sides of the dryer assembly 10 and provide support for the entire dryer assembly as it moves along the support rails 14 with the overhead gantry wash system 12.

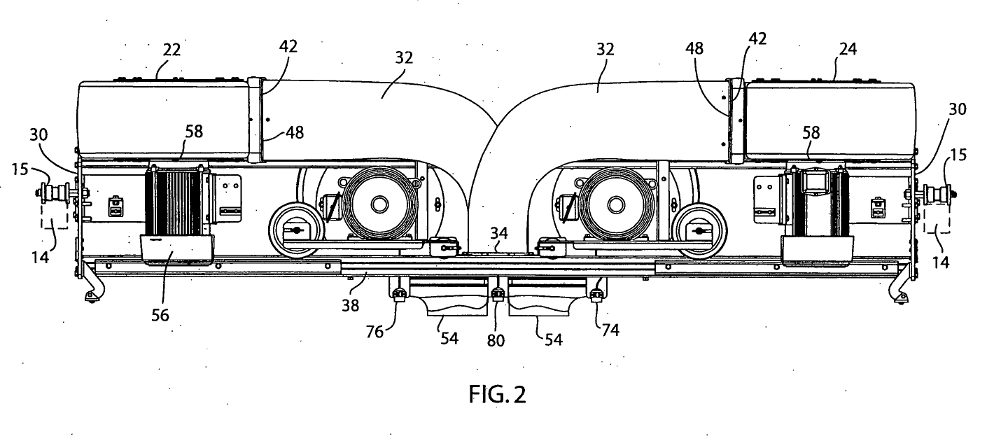

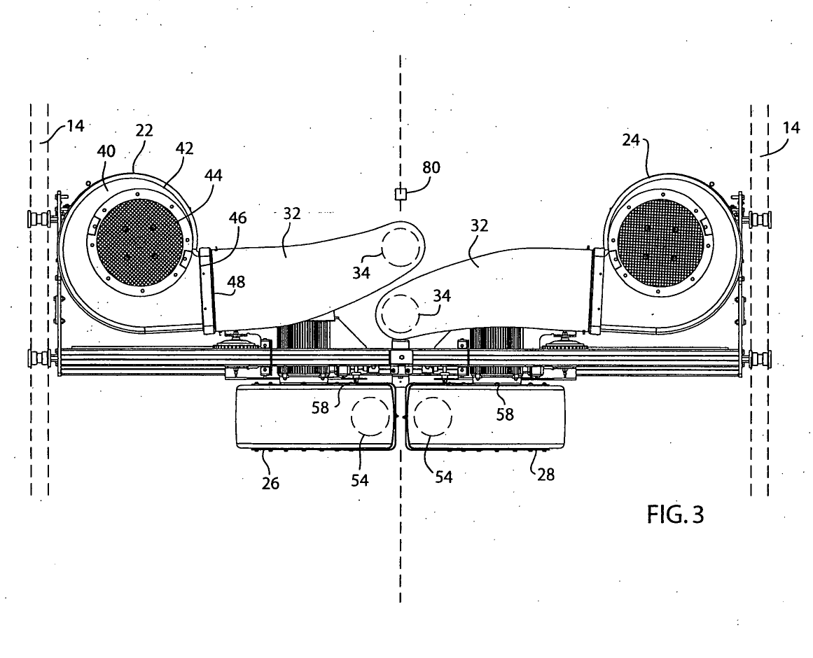

As illustrated in FIGS. 1 and 2, each of the first and second center blower assemblies 22,24 are spaced from the center axis 20 of the vehicle dryer assembly. Each of the center blower assemblies 22,24 includes an air shroud 32 that directs the outlet flow of air from the respective blower assembly 22,24 toward an air outlet 34. As illustrated in FIG. 3, the air outlet 34 of each of the center blower assemblies 22,24 is generally aligned along the center axis of the dryer assembly. In general, the dryer assembly 10 moves along the center axis 20 in the direction illustrated by arrow 16 and the vehicle being dried is generally centered along the center axis 20. However, the position of the vehicle along the center axis 20 can vary slightly as will be described in greater detail below.

Referring back to FIG. 1, the first and second movable blower assemblies 26,28 are supported along a support rail 38 that extends between the pair of spaced side plates 30. The support rail 38 extends generally transverse to the center axis 20 of the dryer assembly 10.

In the embodiment of the invention illustrated in FIG. 1, only the details of dryer assembly 10 are illustrated. It should be understood that the dryer assembly 10 is attached to the overhead gantry wash system 12 used in an in-bay automatic vehicle wash system. The wash components of the wash system 12 are not shown for the ease of understand of the present invention.

Referring now to FIGS. 2 and 3, the first center blower assembly 22, the second center blower assembly 24 and the first and second movable blower assemblies all utilize the same operating components to produce a flow of air to dry the vehicle. Thus, a description of only one of the blower assemblies will be provided with an understanding that each of the blower assemblies have the same overall configuration.

Referring now to FIG. 3, the first center blower assembly 22 includes an outer housing 40 that is defined by a curved outer wall 42. The outer housing 40 includes an air inlet opening 44 that allows a supply of air to be drawn into the outer housing 40 by a rotating internal impeller (not shown). As the impeller rotates in the counter-clockwise direction in FIG. 3, a supply of air is drawn in through the air inlet opening 44 and is directed radially outward against the scroll shaped outer wall 42 of the outer housing 40. In the preferred embodiment of the invention, the outer housing 40 is molded from a durable plastic material, although it is contemplated that the outer housing 40 could be formed from a metallic material.

As the flow of air is directed against the curved outer wall 42 of the outer housing 40, the air is directed by the outer wall toward a housing outlet 46. As illustrated in FIG. 2, the housing outlet 46 is horizontally facing and receives an inlet end 48 of the air shroud 32. The air shroud 32 directs the horizontal air flow from the first center blower assembly 22 vertically downward to the air outlet 34, as best illustrated in FIG. 2.

Although the preferred embodiment of the invention is shown and described as including two separate blower assemblies 22,24 that each include their own drive motor and blower housing, it is contemplated that the first and second center blower assemblies 22,24 could be replaced by a single air producer having increased air flow capacity relative to the two producers shown in the drawings. In the contemplated alternate embodiment, the single air producer would include two separate air conduits to divide the total air output into two air flows directed to the pair of outlets 34.

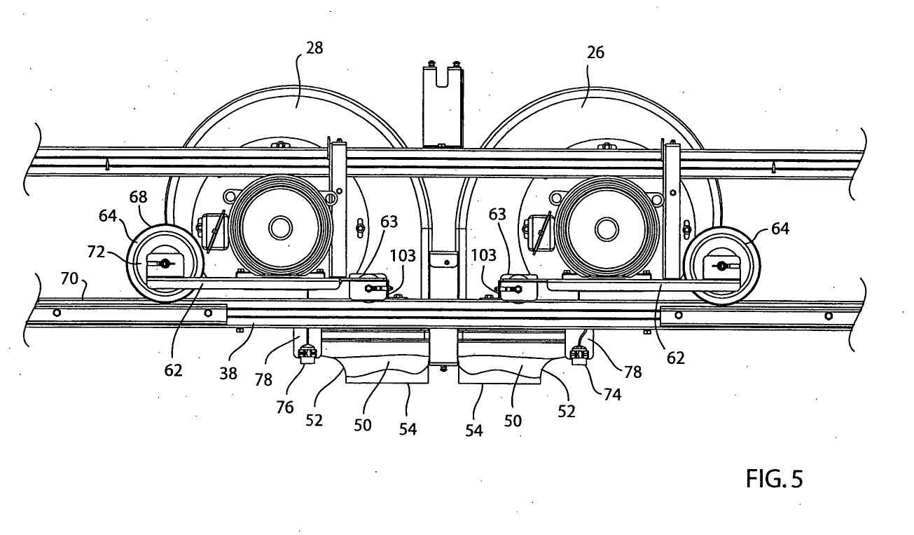

Referring now to FIG. 5, the outer housing 40 of each of the first and second movable blower assemblies 26,28 includes a nozzle 50 having a curved outer wall 52 that defines an outlet opening 54. The curved outer wall 52 of each nozzle 50 aids in directing the flow of air created by the first and second movable blower assemblies 26,28 toward the outlet opening 54 of the nozzle 50. As illustrated in FIG. 5, the outlet opening 54 of each nozzle 50 is directed downward such that each of the blower assemblies 26,28 can direct a supply of air toward the vehicle passing beneath the dryer assembly.

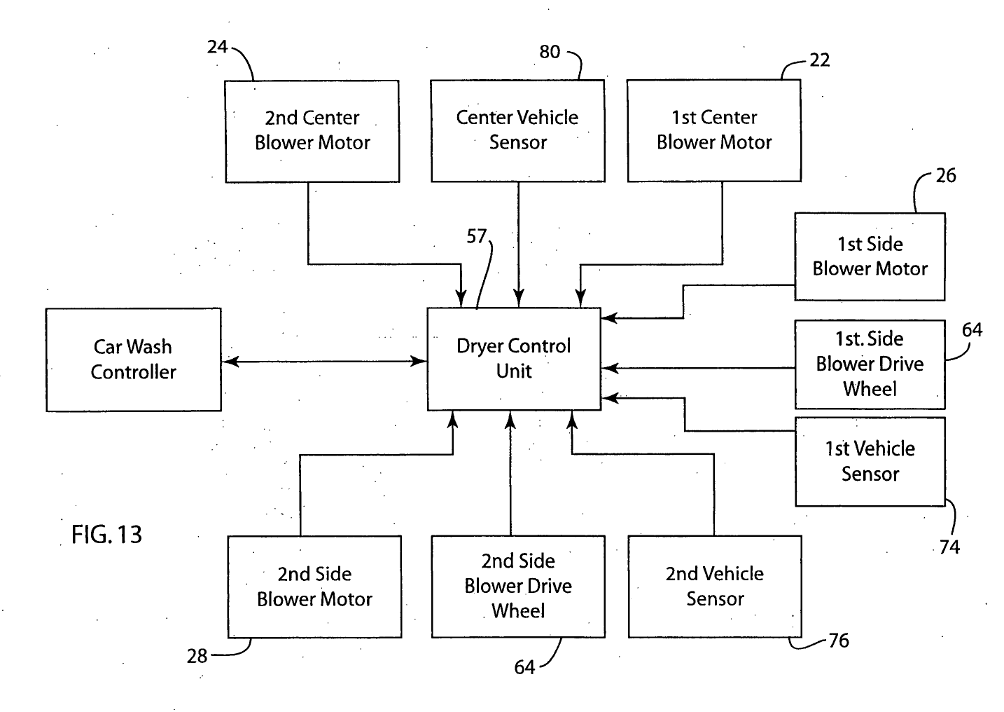

Referring back to FIGS. 2 and 3, each blower assembly includes a blower motor 56 mounted to the back surface 58 of the housing 40 to provide the required motive force to rotate the impeller within the outer housing 40 to create the desired flow of air. In the preferred embodiment of the invention, each blower motor 56 is a 7.5 horsepower, totally enclosed fan cooled motor. The blower motor 56 is coupled to a supply of electricity as well as a control unit 57 for the dryer assembly, as illustrated in FIG. 13. The control unit 57 is operable to control the activation of the blower motors 56 to begin and end a drying sequence. It is contemplated by the inventors that the size of the blower motors 56 could be adjusted depending upon the specific requirements of the dryer assembly.

As illustrated in FIG. 2, the blower motor 56 of both the first center blower assembly 22 and the second center blower assembly 24 are vertically mounted. The vertical mounting of the blower motors 56 allows the first and second center blower assemblies 22,24 to be more closely mounted to the first and second movable blower assemblies 26,28 to present a more compact dryer assembly.

As can be seen in FIG. 3, the outlet opening 34 of both the first center blower assembly 22 and the second center blower assembly 24 is generally aligned with the center axis 20. As described previously, the center axis 20 generally represents the path of the centerline of a vehicle beneath the dryer assembly 10. Thus, both the first center blower assembly 22 and the second center blower assembly 22 direct a flow of outlet air through the respective outlet openings 34 generally along the center axis 20.

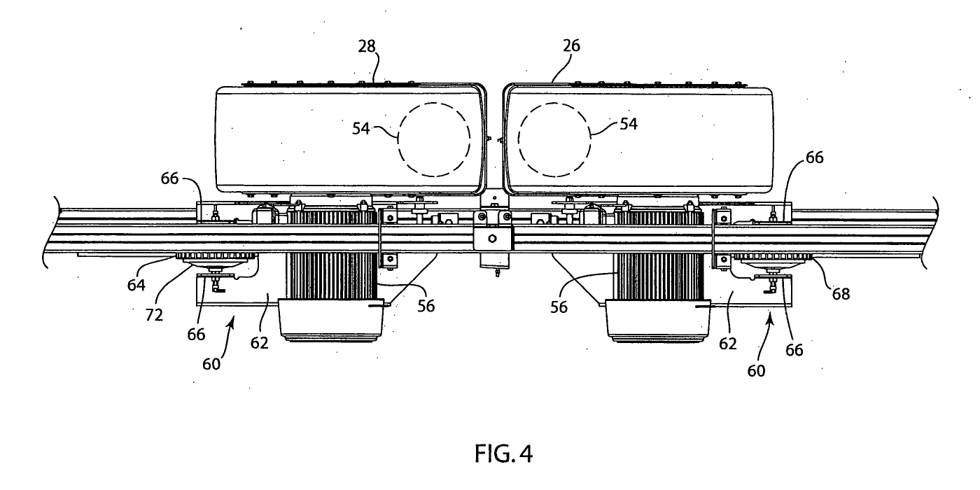

Referring now to FIGS. 4 and 5, the first and second movable blower assemblies 26,28 are each mounted to a trolley assembly 60. The trolley assembly 60 for each of the movable blower assemblies 26,28 allows the respective movable blower assembly 26,28 to move along the support member 38, as will be described in much greater detail below.

As shown in FIG. 4, the drive motor 56 of each of the first and second movable blower assemblies 26,28 is mounted to a support bracket 62 of the trolley assembly 60. As shown in FIG. 5, the support bracket 62 includes a roller assembly 63 and drive wheel 64 that allow the support bracket to move along the support rail 38.

As described previously, each of the first and second side blower assemblies 26,28 is movable along the support member 38. The movement of the first and second movable blower assemblies 26,28 is controlled by the drive wheel 64 mounted between a pair of support plates 66, as shown in FIG. 4. As shown in FIG. 5, the drive wheel 64 includes a treaded outer circumferential contact surface 68 that engages the top surface 70 of the support rail that forms the support member 38. The treaded contact surface 68 provides for generally non-slip contact between the drive wheel 64 and the top surface 70. The drive wheel 64 includes a hub drive motor that is contained within the drive wheel 64 between the two side hubs 72. The self-contained drive motor rotates the drive wheel 64 about its center axis and provides the motive force to move the trolley 60 along the rail of the support member 38. The use of the self-contained motor within the drive wheel 64 allows the trolley assembly to have a more compact design and allows for closer spacing of the first and second movable blower assemblies 26,28. The drive wheel 64 for each of the side blower assemblies 26,28 is connected to a supply of electric power as well as the control unit 57 for the dryer assembly, as shown in FIG. 13. The control unit 57 of the dryer assembly dictates and directs the activation of the drive wheel 64. The drive motor contained within the drive wheel 64 is a DC hub motor that is operable in both a forward and a reverse direction.

Although the movement of each of the trolley assemblies 60 is controlled by the drive wheels 64, it is contemplated by the inventors that the drive wheels 64 could be replaced by other types of assemblies for moving the trolley assemblies 60. As a contemplated example, the movement of the trolley assemblies could be controlled by a belt drive assembly extending between the respective trolley assembly and a drive motor mounted at the outer edges of the dryer assembly 10. Further alternate embodiments for moving the movable blower assemblies 26,28 transverse to the center axis of the dryer assembly are contemplated as being within the scope of the present invention.

Referring back to FIG. 5, the first movable blower assembly 26 includes a first vehicle sensor 74 while the second movable blower assembly 26 includes a second vehicle sensor 76. Both the first and second vehicle sensors 74,76 are mounted to a support tab 78 of the respective trolley 60 used to support the first and second movable blower assemblies 26,28. Both the first and second vehicle sensors 74,76 are spaced away from the support member 38 such that the vehicle sensors 74,76 have an unobstructed downward view toward the floor of the wash bay. In the embodiment of the invention illustrated, both the first and second vehicle sensors 74,76 are ultrasonic sensors that emit an ultrasonic signal downward. The first and second vehicle sensors 74, 76 are used to detect a vehicle passing beneath the dryer assembly and are in communication with the dryer control unit 57, as shown in FIG. 13.

Referring back to FIGS. 2 and 3, the dryer assembly 10 further includes a stationary center vehicle sensor 80. Like the first and second vehicle sensors 74,76, the center vehicle sensor 80 has an unobstructed view downward toward the floor of the wash bay. The center vehicle sensor 80 is preferably an ultrasonic sensor that is operable to detect the presence of a motor vehicle beneath the dryer assembly 10. As shown in FIG. 13, the center vehicle sensor 80 is coupled to the control unit 57 for the dryer assembly such that the signals and information received by the center vehicle sensor 80 are transmitted to the control unit 57 for the dryer assembly.

Referring back to FIGS. 1 and 2, prior to a vehicle entering beneath the dryer assembly 10, the first and second movable blower assemblies 26,28 are each positioned in a center position, as shown. As illustrated in FIG. 3, when the first and second movable blower assemblies 26,28 are in their respective center positions, the outlet 54 of the first movable blower assembly 26 and the outlet 54 of the second movable blower assembly 28 are positioned adjacent to and on opposite sides of the center axis 20.

When the dryer assembly is in its centered condition shown in FIGS. 1 and 2, each of the blower assemblies 22,24,26 and 28 can be operated to create a flow of air to dry a vehicle as the vehicle passes beneath the dryer assembly 10. Since the outlet openings 54 of each of the movable blower assemblies 26, 28 are adjacent the center axis 20, the flow of air from each of the movable blower assemblies 26,28 combine with the flow from the center blower assemblies 22,24 to enhance the air speed of drying air that is directed onto a vehicle.

Although the outlet openings 54 of the first and second movable blower assemblies 26,28 are shown positioned on opposite sides of the center axis, it is contemplated that the blower assemblies 26,28 could be positioned in a different manner such that the outlets 54 would both be centered along the center axis. However, it has been determined that when the blower outlets 54 are positioned very close to each other and generally centered about the center axis of the dryer assembly, the air flow from each of the movable blower assemblies 26,28 combine with each other to enhance the performance of the dryer assembly.

During testing of the dryer assembly shown in FIGS. 1 and 2, the air speed of the air flow leaving the outlet openings of each of the blower assemblies was approximately 185 miles per hour. The air flow velocity measured at the hood of an SUV, which is approximately forty five inches below the outlet openings, was measured at approximately 125 miles per hour. The air flow at the location of a typical car hood, which is approximately sixty inches below the outlet openings, was measured at approximately 110 miles per hour. In a prior art vehicle dryer designs that include three blowers of similar power to the blower assemblies of the present invention only spaced laterally with respect to the wash axis, the air speed at the hood of an SUV is typically measured at approximately 75 miles per hour, while the air speed at the location of a car hood is measured at approximately 55 mph. Thus, the general inline positioning of the blower assemblies in the dryer assembly of the present invention dramatically increases the air speed velocity at both the hood of an SUV and the hood of a car. This increase in air flow results from the “drafting” of the air flows from each of the individual blower assemblies onto each other due to the inline configuration of the blower assemblies along the wash axis.

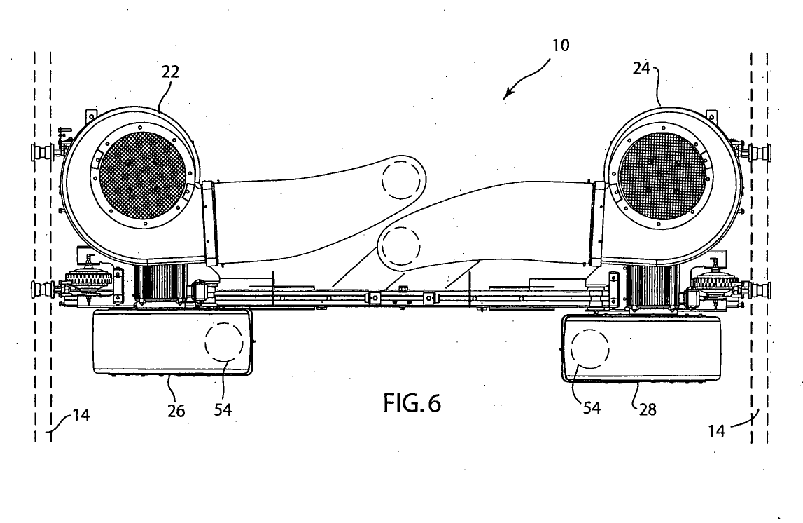

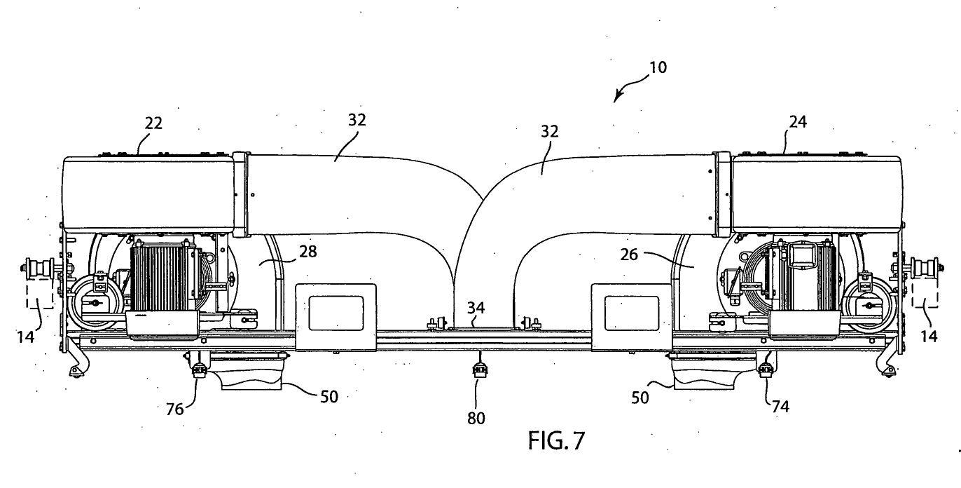

Referring now to FIGS. 6 and 7, thereshown is the dryer assembly 10 in its side drying position. In the side drying position shown in FIG. 6, both the first and second movable blower assemblies 26,28 have been moved to their respective outer positions. In their respective outer positions, the first and second movable blower assemblies 26,28 are positioned in a position to align the outlet openings 54 of the respective nozzles 50 with the opposite sides of a vehicle being dried. As discussed previously, both of the center blower assemblies 22,24 are stationary and remain in general alignment with the center axis 20 as the first and second side blower assemblies 26,28 move to their outer positions.

Referring now to FIG. 7, the movement of the first and second movable blower assemblies 26,28 are controlled by the operation of the drive wheels 64 of each of the trolley assemblies. As can be understood in FIG. 3, the first and second movable blower assemblies 26, 28 are each movable along the support rail 38. As illustrated, the support rail 38 has a longitudinal axis that extends between the pair of side plates 30. When the first and second movable blower assemblies 26,28 move from the center position (FIG. 2) to their respective outer positions (FIG. 7), the first and second movable blower assemblies 26,28 move in opposite directions along the common axis of the support rail 38.

Although the present invention is shown as including a single support rail 38 that provides the support for both the first and second movable blower assemblies 26,28, it is contemplated that other types of support structures could be utilized while operating within the scope of the present invention. The support structure should provide support for the first and second movable blower assemblies 26,28 and permit the blower assemblies to move between their respective center and other positions in a similar manner to that shown and described in the figures.

Based upon market studies and customer surveys, it has been determined that the highest priority and most important area of drying for a customer of a vehicle washing and drying system is the front hood and front windshield of the vehicle. After the front hood and front windshield, the rear window and rear trunk, as well as the driver side and passenger side windows were indicated as being a relatively high priority for the customer. Typically, each of these high priority zones are areas of the vehicle that are viewable by the customer when the customer is within the vehicle and leaving the car wash.

During the same customer surveys, the low priority areas of the vehicle were identified as the body of the vehicle from the handles down, the back and rear bumper, and the roof of the vehicle. Typically, these are the areas of the vehicle that are not viewable by the customer when the customer is within the vehicle or are areas not deemed as critical by the customer. Based upon these customer-identified priority areas, the dryer assembly 10 of the present invention is operated in a manner to focus enhanced drying on the high priority zones while directing less attention to the lower priority zones of the vehicle. The operation of the vehicle dryer assembly of the present invention will now be described.

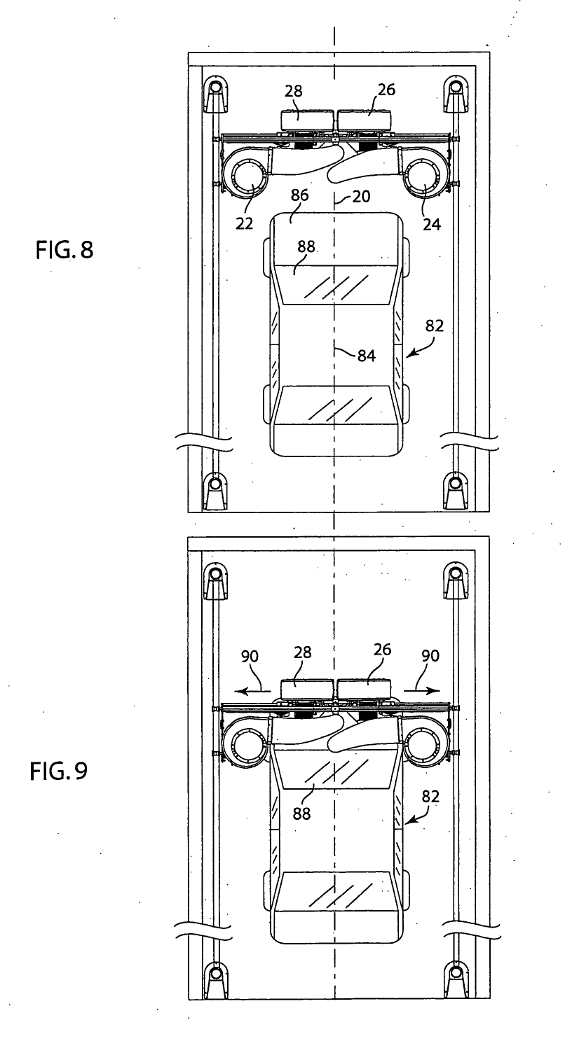

Referring first to FIG. 8, the dryer assembly 10 is shown in its center position prior to the vehicle 82 passing beneath the dryer assembly. As illustrated, the vehicle 82 includes a center axis 84 generally aligned with the center axis 20 of the dryer assembly 10. In the embodiment of the invention illustrated, the vehicle 82 is stationary relative to the moving dryer assembly 10. However, it should also be understood that the vehicle 82 could be moving and the entire dryer assembly 10 stationary relative to the vehicle. The operation of the dryer assembly 10 to be discussed below is equally effective whether the dryer assembly is stationary and the vehicle moving or the dryer assembly is moving relative to a stationary vehicle.

As described previously, when the dryer assembly 10 is in its center position, the outlet openings of the nozzles of the first and second center blower assemblies 22,24 and the outlet openings of the first and second movable blower assemblies 26,28 are generally aligned along the center axis 20. Thus, as the vehicle 82 begins to pass beneath the dryer assembly 10, the outputs of all of the blower assemblies are generally aligned along the center axis 20.

As the vehicle 82 enters beneath the first and second center blower assemblies 20,24, the flow of drying air from both the first and second center blower assemblies 20,24, as well as the flow from the first and second movable blower assemblies 28,28 is directed along the center vehicle axis 84 and onto the front hood 86 and front windshield 88 of the vehicle 82. As described previously, the front hood 86 and the front windshield 88 were identified as being the highest priority area of a vehicle for drying to increase customer satisfaction. When all of the blower assemblies are aligned along the center axis 20, the combined air flow from all of the blower assemblies creates a significantly increased amount of air flow which aids in the drying of the hood 86.

As the motor vehicle 82 moves further beneath the dryer assembly 10 as shown in FIG. 9, the windshield 88 passes beneath the center vehicle sensor 80, best illustrated in FIG. 3. As described previously, the center vehicle sensor 80 is an ultrasonic sensor that directs an ultrasonic signal downward toward the floor of the wash bay. As shown in FIG. 13, the ultrasonic center vehicle sensor 90 is coupled to the control unit 57 for the dryer assembly. As the motor vehicle 82 passes beneath the center vehicle sensor 80, the control unit 57 interprets the signals from the sensor 80 and creates a top profile of the vehicle 82. In most motor vehicles, the slope of the front windshield 88 increases relative to the slope of the front hood 86. Upon detecting this change in slope, the control unit 57 can identify when the front windshield 88 is passing beneath the center vehicle sensor 80.

Once the control unit 57 for the dryer assembly detects the front windshield 88, the control unit 57 activates the drive wheels 64 of the first and second movable blower assemblies 26,28 to move the movable blower assemblies 26,28 away from the center axis 20, as illustrated by arrows 90 in FIG. 9. Thus, as can be understood in FIG. 9, the transition from the front hood 86 to the front windshield 88 is the first vehicle area that, upon sensing, results in the movement of the first and second movable blower assemblies 26, 28 away from the center axis 20.

Although the transition between the front hood 86 and the front windshield 88 is contemplated as being the first priority area of the vehicle, it is contemplated that a car wash system including the dryer assembly could include the ability for the customer to select the priority area of the vehicle for enhanced drying. In such a system, the customer of the vehicle wash system including the dryer assembly could input information to select the priority areas into either the dryer control unit 57 or the car wash controller shown in FIG. 13. As an example, some customers may not deem the front hood of the vehicle as the priority zone, but may instead wish to provide enhanced drying for other areas of the vehicle. Since the center vehicle sensor 80 can detect the entire top profile of the vehicle, the dryer control unit 57 could control the operation of a movable blower assembly 26,28 to provide enhanced drying to other areas of the vehicle.

Further, the dryer control unit 57 can include internal programming that determines the type of vehicle based upon the profile detected by the center vehicle sensor 80. Based on the type of vehicle detected, the dryer control unit can change the priority areas of the vehicle. As an example, if the center vehicle sensor detects the top profile of a large pickup truck, the priority zones may be adjusted to optimize the drying process for the vehicle being dried.

As the first and second movable blower assemblies 26, 28 move away from the center position, the first and second vehicle sensors 74, 76 provide a signal to the control unit 57 of the vehicle dryer. Since the first and second vehicle sensors 74,76 are mounted to the moving trolley assemblies 60, the first and second vehicle sensors 74,76 are movable along with the trolley assemblies 60.

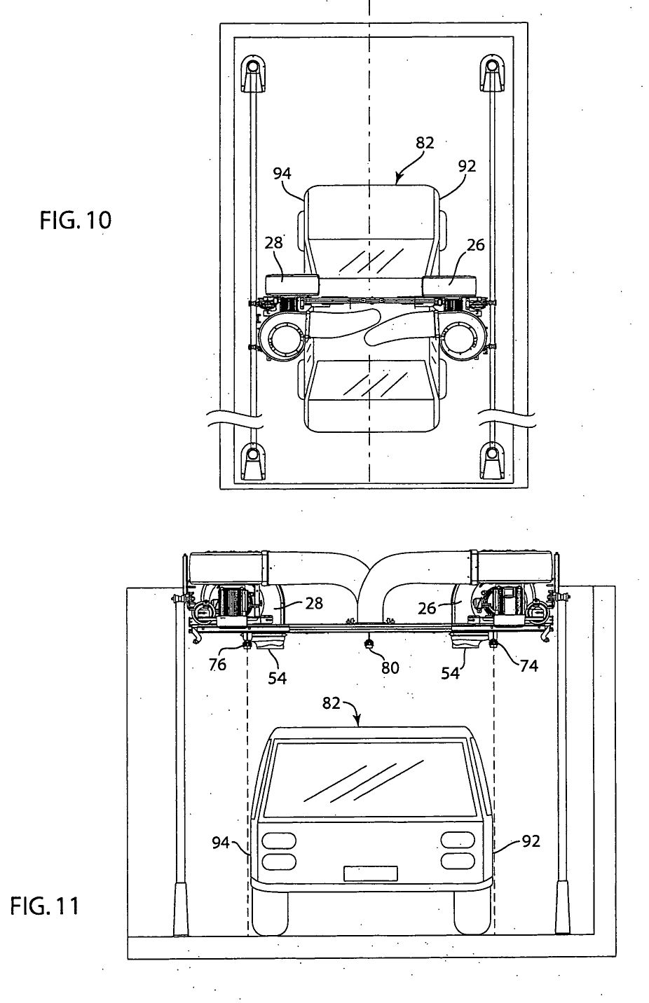

As the first and second movable blower assemblies 26,28 move outward away from the center axis 20, the control unit 57 monitors the information from the first and second vehicle sensors 74,76 until the first and second vehicle sensors 26,28 detect a dramatic change associated with the first side 92 and the second side 94 of the vehicle, as shown in FIG. 10. Specifically, each of the first and second vehicle sensors 74,76 are ultrasonic sensors that are able to detect the sharp transition from the vehicle to the wash bay floor as the respective first and second movable blower assemblies 26,28 move laterally outward.

Although the first and second vehicle sensors 74,76 are described as being ultrasonic sensors, it is contemplated by the inventors that the first and second vehicle sensors 74,76 could be replaced by an overhead camera system. An overhead camera system would be operable to detect the sides of the vehicle and relay information to the control unit 57 as to the relative position of the vehicle sides within the wash bay. Once the control unit 57 knows the position of the vehicle size, the control unit can control the operation and movement of the first and second movable blower assemblies 26,28 in a similar manner set forth below to align the movable blower assemblies 26,28 with the sides of the vehicle being dried.

Once the first and second vehicle sensors 74,76 detect the sides of the vehicle, the control unit 57 for the dryer assembly terminates operation of the drive wheels 64. Once the operation of the drive wheels 64 has been terminated, the first movable blower assembly 26 is generally aligned with the first side 92 of the vehicle, while the second movable blower assembly 28 is generally aligned with the second side 94 of the vehicle.

As the first and second movable blower assemblies 26,28 move away from the center position, the first and second vehicle sensors 74,76 may detect the sides of the vehicle at different times, depending on whether the vehicle is centered beneath the dryer assembly. In accordance with the present invention, the control unit 57 receives separate signals from the first and second vehicle sensors 74,76 such that the control unit 57 can terminate operation of the drive wheels 64 separately. Thus, if the vehicle is not centered beneath the dryer assembly, the control unit 57 can stop movement of the first movable blower assembly 26 before or after stopping the movement of the second movable blower assembly 26. In the preferred embodiment of the invention, both the first and second movable blower assemblies 26,28 include a braking device that can be actuated to hold the movable blower assembly in its outer position.

Although the preferred embodiment of the invention includes the first and second vehicle sensors 74,76 to detect the sides of the vehicle, the control unit 57 could be configured to move the first and second movable blower assemblies 26,28 a predetermined distance from the center position either based upon the type of vehicle being dried or a set value corresponding to an average vehicle width. Although the first and second movable blower assemblies 26,28 would not be as accurately aligned with the vehicle sides as in a system that incorporates the first and second vehicle sensors 74,76, the first and second movable blowers assemblies 26,28 would be moved to a position near the sides of the vehicle to enhance drying of the vehicle.

As illustrated in FIG. 11, the control unit 57 stops the blower assemblies 26,28 such that the outlet 54 of the second movable blower assembly 28 is generally aligned above the second side 94 of the vehicle 82, while the outlet 54 of the first movable blower assembly 26 is generally aligned along the first side 92 of the vehicle. When the first and second movable blower assemblies 26,28 are in the position shown in FIG. 11, the flow of air created by each of the blower assemblies 26,28 is directed along the side of the vehicle to provide drying for the vehicle sides, including the driver side window and the passenger side window.

As can be understood in FIGS. 10 and 11, the outer position for both the first movable blower assembly 26 and the second movable blower assembly 28 is generally defined by the sides 92,94 of the vehicle 82. The movement of each of the movable blower assemblies 26,28 is controlled by the control unit 57 for the vehicle dryer assembly 10, which terminates the movement of the movable blower assemblies 26,28 based upon signals received from the vehicle sensors 74,76.

During the design and testing of the dryer assembly of the present invention, it was determined that to most effectively dry the driver side window and the passenger side window, the outlets 54 of both of the movable blower assemblies 26,28 must be closely aligned with the side windows of the vehicle. To control the position of the movable blower assemblies, the control unit 57 can be operated to detect changes in the top profile of the vehicle as the movable blower assemblies 26,28 move from the center position toward the outer position. Instead of detecting the dramatic change from the top of the vehicle to the wash bay floor, the system can be operated to detect the change in the top profile of the vehicle from the narrow roof area to a wider side edge of the vehicle. In this manner, the dryer assembly can most effectively dry the side windows of the vehicle.

As the vehicle moves beneath the dryer assembly, the control unit controls the position of the first and second movable blower assemblies 26,28 continuously based upon the signals received from the first and second vehicle sensors 74,76. As an example, if the vehicle is positioned at an angle within the wash bay, the control unit may continuously adjusts the position of the first and second movable blower assemblies 26,28 such that the blower assemblies maintain the proper position above the vehicle sides. By continuously adjusting the position of the first and second movable blower assemblies 26,28, the dryer assembly can ensure better drying of the vehicle sides.

In the embodiment of the invention described, the pair of vehicle sensors 74,76 operate to find the sides of the vehicle as the movable blower assemblies 26,28 move from the center position to the outer positions. In an alternate embodiment, the vehicle sensors could be replaced with side sensors mounted to the side walls of the wash bay (or other stationary locations) that detect the sides of the vehicle. The distance from the side walls of the wash bay to the vehicle sides can be measured and relayed to the control unit of the dryer assembly. These measurements would then be stored in memory such that the control unit would know the position of the vehicle in the wash bay upon beginning the drying cycle. In such an embodiment, the movement of the movable blower assemblies can be monitored by a sensor or encoder mounted to the drive wheel such that the position of the outlet for each movable blower assembly is known. In this manner, the control unit can operate the drive wheels to position the blower assemblies in the correct position above the vehicle sides.

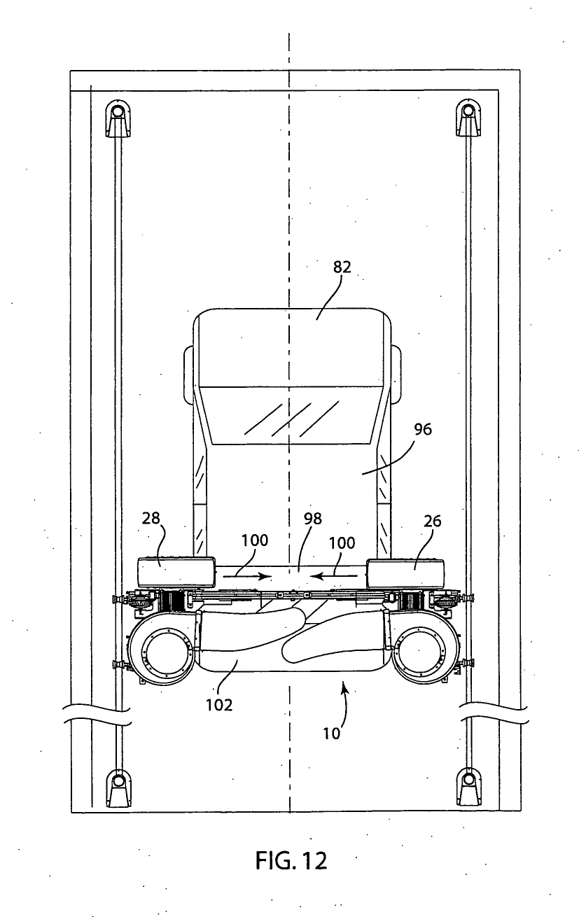

Referring now to FIG. 12, as the vehicle 82 continues to move beneath the dryer assembly 10, the center vehicle sensor again senses the transition from the roof 96 to the back windshield 98. The transition from the roof to the back windshield defines a second vehicle priority area that triggers the movement of the first and second movable blower assemblies 26,28 in the direction shown by arrows 100. Specifically, each of the first and second movable blower assemblies 26,28 move from their respective outer position back toward the center position shown in FIG. 8. As the first and second movable blower assemblies 26,28 move in the direction shown by arrows 100, the movable blower assemblies provide enhanced drying for the rear windshield 98 as well as for the rear trunk area 102. Both the rear windshield 98 and the rear trunk 102 were also identified through customer survey as being priority areas for enhanced drying.

Once the vehicle 82 moves completely from beneath the dryer assembly 10, the dryer assembly is again in the center position shown in FIG. 8 and ready to receive the next vehicle to be dried.

As shown in FIG. 2, the movement of the first and second movable blower assemblies 26,28 to the center position are determined by physical stops 103 mounted along the center area of the support member 38. The physical stops 103 limit the movement of the individual trolley assembly 60 toward the center of the support member 38. As previously described, the movement of the first and second movable blower assemblies 26,28 outward is controlled by the sensing of the vehicle sides by the individual ultrasonic first and second vehicle sensors 74,76.

Although the present invention has been shown and described as including first and second movable blower assemblies 26,28 that each include an air outlet and a producer that move transverse to the center axis of the vehicle dryer, it is contemplated that the producer could be stationery and the air outlet that receives the flow of air from the producer could move transverse to the center axis. In such an embodiment, only the air outlet would move transverse to the center axis of the vehicle and dryer assembly. In such a system, the movement of the air outlet would be controlled in the same manner as the movement of the entire movable blower assembly. Additionally, it is contemplated by the inventors that in such an embodiment, the outlet for each moveable blower assembly could also move along the center axis of the dryer assembly in addition to the transverse movement. As an example, the outlet for each of the moveable blower assemblies could be fixed to a pivot mechanism that simultaneously moves the outlet both transverse and parallel to the center axis of the dryer assembly.

In yet another alternate embodiment contemplated by the inventors, the pair of movable blower assemblies 26,28 could be replaced by a single blower assembly that includes two separate blower conduits each having an outlet. Each of the two outlets in communication with the single blower would be separately movable between the center and outer positions described above.

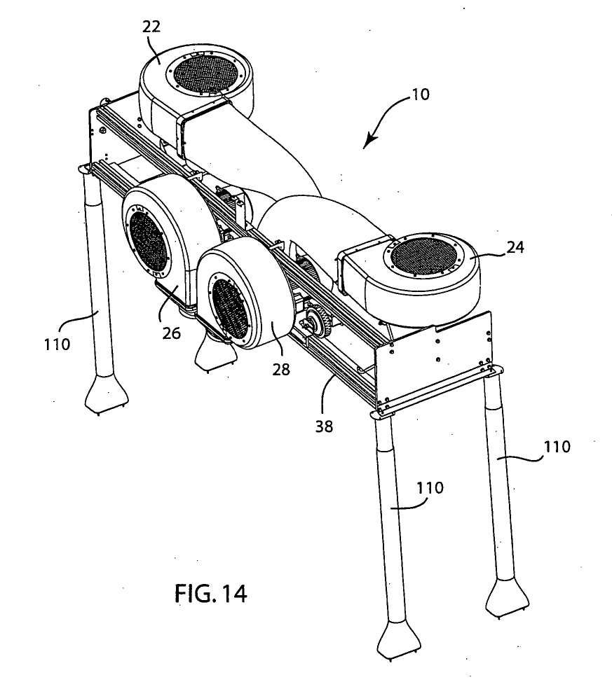

Referring now to FIG. 14, thereshown is an alternate embodiment for the dryer assembly 10 of the present invention. In the alternate embodiment, the dryer assembly 10 is stationary such as included at the end of a car wash or at the exit of an in-bay vehicle washing system. The dryer assembly 10 includes the pair of center blower assemblies 22,24 as well as the pair of movable blower assemblies 26,28. Both of the movable blower assemblies 26,28 are movable along the support member 38 which is mounted between the pair of side plates 30. Unlike the dryer assembly of the first embodiment of the invention that moves along the length of a pair of support rails, the dryer assembly 10 shown in FIG. 14 is stationary and mounted to a pair of support legs 110,112. The dryer assembly 10 shown in FIG. 14 operates in the same manner as the dryer assembly previously discussed. In the embodiment shown in FIG. 14, the dryer assembly 10 is stationary while the vehicle moves beneath the dryer assembly.

In addition to the motor vehicle dryer assembly 10 shown in FIG. 14, it is contemplated that the dryer assembly 10 could utililize only a single center blower assembly and the pair of movable blower assemblies 26, 28. The alternate embodiment that includes only a single center blower assembly is particularly desirable in locations where the electric service to the car wash/dryer is serviced by a lower rated electrical circuit. Unlike the embodiment shown in the figures, an embodiment that includes only a single center blower assembly thus includes only three drive motors such that the dryer assembly draws a lower amount of overall current from the electrical power grid.

Various alternatives and embodiments are contemplated as being within the scope of the following claims particularly pointing out and distinctly claiming the subject matter regarded as the invention.

1. A dryer for drying a vehicle having a center axis, a first vehicle side and a second vehicle side, the dryer comprising:
a first movable blower assembly positioned above the vehicle and operable to direct a flow of air onto the vehicle, the first blower assembly being movable transverse to the vehicle center axis; and
a second movable blower assembly positioned above the vehicle and operable to direct a flow of air onto the vehicle, the second blower assembly being movable transverse to the vehicle center axis.

2. The dryer of claim 1 further comprising a support mounted above the vehicle and extending transverse to the center axis, wherein both the first movable blower assembly and the second movable blower assembly are movable along the support.

3. The dryer of claim 2 wherein the movement of the first movable blower assembly along the support and the movement of the second movable blower assembly along the support is transverse to the center axis of the vehicle.

4. The dryer of claim 1 wherein the first movable blower assembly is movable between a center position and an outer position, and the second movable blower assembly is movable between a center position and an outer position.

5. The dryer of claim 4 wherein the movement of the first movable blower assembly from the center position to the outer position is in a direction away from the movement of the second movable blower assembly from the center position to the outer position.

6. The dryer of claim 5 wherein the first movable blower assembly and the second movable blower assembly are generally aligned with a center axis of the dryer when the first and second side blower assemblies are in the center position.

7. The dryer of claim 1 further comprising a center vehicle sensor operable for detecting the vehicle as the vehicle passes beneath the center vehicle sensor.

8. The dryer of claim 1 further comprising:
a first vehicle sensor operable to detect the first side of the vehicle as the first movable blower assembly moves transverse to the vehicle center axis; and
a second vehicle sensor operable to detect the second side of the vehicle as the second movable blower assembly moves transverse to the vehicle center axis.

9. The dryer of claim 7 wherein the center vehicle sensor is operable to detect a top profile of the vehicle as the vehicle passes beneath the center vehicle sensor.

10. The dryer of claim 9 wherein the first movable blower assembly moves to an outer position and the second movable blower assembly moves to an outer position upon detection of a first priority area of the vehicle by the center vehicle sensor.

11. The dryer of claim 2 wherein the support is a support rail, wherein both the first movable blower assembly and the second movable blower assembly include a trolley movable along the support rail.

12. The dryer of claim 11 wherein the first movable blower assembly includes a first drive wheel mounted to the trolley of the first movable blower assembly and positioned to engage the support rail; and
wherein the second movable blower assembly includes a second drive wheel mounted to the trolley of the second movable blower assembly and positioned to engage the support rail.

13. The dryer of claim 1 wherein the first movable blower assembly and the second movable blower assembly are mounted on a movable overhead gantry, the movable overhead gantry being movable generally along the center axis of the vehicle.

14. The dryer of claim 10 further comprising a control unit in communication with the first vehicle sensor and the second vehicle sensor, wherein the control unit controls the movement of the first movable blower assembly to the outer position such that the first movable blower assembly is generally aligned above the first side of the vehicle and wherein the control unit controls the movement of the second movable blower assembly to the outer position such that the second movable blower assembly is generally aligned above the second side of the vehicle.

15. A dryer for drying a vehicle having a center axis, a first vehicle side and a second vehicle side, the dryer comprising:
a first movable blower assembly positioned above the vehicle and operable to direct a flow of air onto the vehicle, the first blower assembly being movable transverse to the vehicle center axis between a center position and an outer position;
a second movable blower assembly positioned above the vehicle and operable to direct a flow of air onto the vehicle, the second blower assembly being movable transverse to the vehicle center axis between a center position and an outer position;
a first vehicle sensor operable to detect the first vehicle side as the first movable blower assembly moves from the center position to the outer position; and
a second vehicle sensor operable to detect the second vehicle side as the second movable blower assembly moves from the center position to the outer position.

16. The dryer of claim 15 further comprising
the first drive member operable to move the first movable blower assembly transverse to the center axis between the center position and the outer position; and
the second drive member operable to move the second movable blower assembly transverse to the center axis between the center position and the outer position.

17. The dryer of claim 16 further comprising a control unit in communication with both the first drive member and the second drive member to control the movement of the first movable blower assembly and the second movable blower assembly, wherein the control unit is in communication with both the first vehicle sensor and the second vehicle sensor.

18. The dryer of 17 further comprising a center vehicle sensor in communication with the control unit, the center vehicle sensor being operable to detect the vehicle as the vehicle passes beneath the center vehicle sensor.

19. The dryer of claim 15 wherein the movement of the first movable blower assembly from the center position to the outer position is in a direction away from the movement of the second movable blower assembly from the center position to the outer position.

20. The dryer of claim 15 wherein the first vehicle sensor and the second vehicle sensor are ultrasonic sensors.

21. The dryer of claim 18 wherein the center vehicle sensor is an ultrasonic sensor.

22. The dryer of claim 15 further comprising a stationary center blower assembly including a first center blower and a second center blower each having a blower outlet generally aligned with the center axis of the dryer.

23. The dryer of claim 18 wherein the control unit is operable to determine at least a first priority area of the vehicle based upon the detection of the vehicle by the center vehicle sensor, wherein the control unit is operable to move the first movable blower assembly and the second movable blower assembly from the center position upon detection of the first priority area.

24. The dryer of claim 15 wherein the first movable blower assembly and the second movable blower assembly are mounted on a movable overhead gantry, the movable overhead gantry being movable generally along the center axis of the vehicle.

25. The dryer for drying a vehicle having a center axis, a first vehicle side and a second vehicle side, the dryer comprising:
a first movable blower outlet positioned above the vehicle and operable to direct a flow of air onto the vehicle, the first movable blower assembly being movable transverse to the vehicle center axis;
a second blower outlet positioned above the vehicle and operable to direct a flow of air onto the vehicle, the second movable blower assembly being movable transverse to the center axis; and
a control unit operable to control the movement of the first movable blower outlet and the second movable blower outlet, wherein the control unit is operable to selectively position the first movable blower outlet above the first vehicle side and to position the second movable blower outlet above the second vehicle side.

26. The dryer of claim 25 further comprising:
a first vehicle sensor mounted for movement with the first movable blower outlet and operable to detect the first vehicle side as the first movable blower outlet moves from a center position an outer position, the first vehicle sensor being in communication with the control unit; and
a second vehicle sensor mounted to the second movable blower outlet and operable to detect the second vehicle side as the second movable blower outlet moves from a center position to an outer position, the control unit being in communication with the second vehicle sensor.

27. The dryer of claim 25 further comprising:
a stationery center blower assembly positioned above a center axis of the dryer and operable to direct a flow of air onto the vehicle.

28. The dryer of claim 24 further comprising:
a center vehicle sensor positioned for detecting the vehicle as the vehicle passes beneath the center vehicle sensor, the center vehicle sensor being in communication with the control unit.
